(19) United States
(12) Patent Application Publication
(10) Pub. No.: US 2021/0363343 A1
(43) Pub. Date: Nov. 25, 2021

(54) VINYL CHLORIDE RESIN COMPOSITION FOR POWDER MOLDING, VINYL CHLORIDE RESIN MOLDED BODY, AND LAMINATE

(71) Applicants: KANEKA CORPORATION, Osaka (JP); TATSUTA CHEMICAL CO., LTD., Tokyo (JP)

(72) Inventors: Kentaro Takesada, Ibaraki (JP); Junpei Wakamatsu, Hyogo (JP); Kohei Hosomi, Hyogo (JP)

(73) Assignees: KANEKA CORPORATION, Osaka (JP); TATSUTA CHEMICAL., lTD., Tokyo (JP)

(21) Appl. No.: 17/395,573

(22) Filed: Aug. 6, 2021

Related U.S. Application Data
(63) Continuation of application No. PCT/JP2020/008685, filed on Mar. 2, 2020.

(30) Foreign Application Priority Data
Mar. 7, 2019 (JP) 2019-041514

(51) Int. Cl. C08L 67/02; C08F 220/14; C08G 18/76; C08G 18/48; C08G 18/20; C08J 9/12; B32B 5/18; B32B 27/06; B32B 27/40; B32B 27/30

(52) U.S. Cl. CPC C08L 67/02; B29C 41/18; C08G 18/7671; C08G 18/4829; C08G 18/2063; C08J 9/125; B32B 5/18; B32B 27/065; B32B 27/40; B32B 27/304; C08G 2110/0083; C08L 2205/035; C08L 2205/025; C08L 2205/06; C08L 2203/14; C08J 2201/022; C08J 2203/10; C08J 2375/08; B32B 2266/0278; B32B 2250/02; B32B 2250/24; B32B 2605/003; C08F 220/14

(57) ABSTRACT

A polyvinyl chloride composition for powder molding includes 100 parts by mass of a polyvinyl chloride, 120 parts by mass or more and 200 parts by mass or less of a polyester-based plasticizer, and 4 parts by mass or more and 23 parts by mass or less of an acrylic polymer. The polyvinyl chloride has an average particle diameter of 50 μm or more and 500 μm or less and an average degree of polymerization of 1,700 or more. The acrylic polymer contains 40 mass % or more and 95 mass % or less of a constitutional unit derived from methyl (meth)acrylate, and 5 mass % or more and 60 mass % or less of a constitutional unit derived from at least one (meth)acrylic ester selected from the group consisting of a (meth)acrylic ester of an aliphatic alcohol having two or more carbon atoms and a (meth)acrylic ester of an aromatic alcohol.

### TECHNICAL FIELD

One or more embodiments of the present invention relate to a polyvinyl chloride composition for powder molding to be suitably used for powder slush molding, a polyvinyl chloride molded body, and a laminate.

### BACKGROUND

A polyvinyl chloride composition has excellent chemical resistance and durability. In addition, a molded body obtained by molding a polyvinyl chloride composition blended with a plasticizer has excellent flexibility and a favorable texture and imparts a sense of luxuriousness, and is thus often used as a facing material for automobile interior parts such as an instrument panel and a door trim. In particular, a laminate and the like formed of a molded body obtained by molding a polyvinyl chloride composition through powder slush molding and polyurethane foam or the like is suitably used for automobile interior parts.

However, a molded body obtained by molding a polyvinyl chloride composition blended with a plasticizer has a problem in that the plasticizer moves to the surface of the molded body under the influence of heat, light, or the like, and thus the flexibility of the molded body is likely to decrease. Therefore, the blend amount of the plasticizer is increased in order to improve the flexibility, but an increase in the blend amount of the plasticizer poses a problem in that, when a piece of cloth is used to wipe off dirt on the surface of the molded body, fibers attach to the surface. To address this, Patent Document 1 proposes that adhesion of fuzz to a polyvinyl chloride composition and bleeding out of an additive in a polyvinyl chloride composition can be suppressed by further blending hydroxyl group-modified silicone oil into the polyvinyl chloride composition blended with a plasticizer. Patent Document 2 proposes that the surface characteristics and flexibility of a molded body are improved by using a polyvinyl chloride composition containing two types of polyvinyl chloride particles having different average particle diameters, and modified polyorganosiloxane particles.

[Patent Document 1] JP 2012-7026A

[Patent Document 2] JP 2015-117314A

However, for the molded bodies made of the polyvinyl chloride compositions disclosed in Patent Documents 1 and 2, there has been demanded to further improve the surface characteristics while favorably maintaining flexibility at low temperatures.

One or more embodiments of the present invention provide a polyvinyl chloride composition for powder molding from which a molded body having high flexibility at low temperatures as well as favorable surface characteristics can be produced, a polyvinyl chloride molded body, and a laminate.

### SUMMARY

One or more embodiments of the present invention relate to a polyvinyl chloride composition for powder molding including: a polyvinyl chloride (A) in an amount of 100 parts by mass; a polyester-based plasticizer in an amount of 120 parts by mass or more and 200 parts by mass or less; and an acrylic polymer in an amount of 4 parts by mass or more and 23 parts by mass or less, wherein the polyvinyl chloride (A) has an average particle diameter of 50 μm or more and 500 μm or less and an average degree of polymerization of 1,700 or more, and the acrylic polymer contains a constitutional unit derived from methyl (meth)acrylate in an amount of 40 mass % or more and 95 mass % or less, and a constitutional unit derived from at least one (meth)acrylic ester selected from the group consisting of a (meth)acrylic ester of an aliphatic alcohol having two or more carbon atoms and a (meth)acrylic ester of an aromatic alcohol in an amount of 5 mass % or more and 60 mass % or less.

It is preferable that the acrylic polymer has an average particle diameter of 0.01 μm or more and 10 μm or less. It is preferable that the acrylic polymer contains a constitutional unit derived from methyl (meth)acrylate in an amount of 40 mass % or more and 95 mass % or less, and a constitutional unit derived from at least one (meth)acrylic ester selected from the group consisting of n-butyl (meth)acrylate, isobutyl (meth)acrylate, and tert-butyl (meth)acrylate in an amount of 5 mass % or more and 60 mass % or less. It is preferable that the polyvinyl chloride composition for powder molding further includes a polyvinyl chloride (B) having an average particle diameter of 0.05 μm or more and less than 50 μm, and a blend amount of the polyvinyl chloride (B) is 36 parts by mass or less with respect to 100 parts by mass of the polyvinyl chloride (A). It is preferable that the polyvinyl chloride composition for powder molding further includes an acrylic modified polyorganosiloxane, and a blend amount of the acrylic modified polyorganosiloxane is 5 parts by mass or less with respect to 100 parts by mass of the polyvinyl chloride (A).

In one or more embodiments of the present invention, it is preferable that the polyvinyl chloride composition for powder molding is used in powder slush molding.

One or more embodiments of the present invention also relate to a polyvinyl chloride molded body obtained by molding the polyvinyl chloride composition for powder molding through powder slush molding.

In one or more embodiments of the present invention, it is preferable to use the polyvinyl chloride molded body as a facing for a vehicle interior material.

One or more embodiments of the present invention also relate to a laminate obtained by laminating a polyurethane foam layer and the polyvinyl chloride molded body.

In one or more embodiments of the present invention, it is preferable to use the laminate as a vehicle interior material.

With one or more embodiments of the present invention, it is possible to provide a polyvinyl chloride composition for powder molding from which a molded body having high flexibility at low temperatures as well as favorable surface characteristics can be produced. With one or more embodiments of the present invention, it is possible to provide a polyvinyl chloride molded body having high flexibility at low temperatures and favorable surface characteristics, and a laminate produced using the polyvinyl chloride molded body.

### DETAILED DESCRIPTION

The inventors of the present invention conducted numerous studies. As a result, they found that, in a polyvinyl chloride composition, when a polyvinyl chloride (A) having an average degree of polymerization of 1,700 or more and an average particle diameter of 50 μm or more and 500 μm or less, a polyester-based plasticizer, and an acrylic polymer containing a constitutional unit derived from methyl (meth)acrylate in an amount of 40 mass % or more and 95 mass % or less, and a constitutional unit derived from at least one (meth)acrylic ester selected from the group consisting of a (meth)acrylic ester of an aliphatic alcohol having two or more carbon atoms and a (meth)acrylic ester of an aromatic alcohol in an amount of 5 mass % or more and 60 mass % or less are used in combination in predetermined amounts, a polyvinyl chloride molded body obtained by molding the polyvinyl chloride composition had high flexibility at a low temperature and had favorable surface characteristics (had a low dynamic friction coefficient). This means that, the lower the dynamic friction coefficient of the polyvinyl chloride molded body is, the less sticky the polyvinyl chloride molded body is.

There is no particular limitation on the average degree of polymerization of the polyvinyl chloride (A) as long as it is 1,700 or more. The average degree of polymerization may be 2,000 or more from the viewpoint of more easily forming the powder of the polyvinyl chloride composition. In addition, there is no particular limitation on the upper limit of the average degree of polymerization of the polyvinyl chloride (A), and it may be 3,800 or less, for example. The average degree of polymerization may be 3,500 or less, or 3,000 or less, from the viewpoint of improving the flexibility at a low temperature of a polyvinyl chloride molded body obtained by molding the polyvinyl chloride composition. More specifically, the average degree of polymerization of the polyvinyl chloride (A) may be 1,700 or more and 3,800 or less, 1,700 or more and 3,500 or less, or 2,000 or more and 3,000 or less. In one or more embodiments of the present invention, the average degree of polymerization of the polyvinyl chloride (A) is measured in accordance with JIS K 6720-2: 1999.

There is no particular limitation on the average particle diameter of the polyvinyl chloride (A) as long as it is 50 μm or more and 500 μm or less, and for example, it may be 100 μm or more, or 150 μm or more. The average particle diameter of the polyvinyl chloride (A) may be 300 μm or less, or 200 μm or less, for example. More specifically, the average particle diameter of the polyvinyl chloride (A) may be 100 μm or more and 300 μm or less, 100 μm or more and 200 μm or less, or 150 μm or more and 200 μm or less, for example. When the average particle diameter of the polyvinyl chloride (A) is within the above-described range, the fluidity of the powder of the polyvinyl chloride composition is improved, and the adhesiveness of a polyvinyl chloride molded body obtained by molding the polyvinyl chloride composition to a polyurethane foam layer is improved. In one or more embodiments of the present invention, the average particle diameter of the polyvinyl chloride (A) is measured in accordance with JIS K 7369: 2009.

There is no particular limitation on the polyvinyl chloride (A), and a homopolymer of a vinyl chloride monomer and/or a copolymer of a vinyl chloride monomer and another copolymerizable monomer can be used. Examples of the other copolymerizable monomer include, but are not particularly limited to, ethylene, propylene, vinyl acetate, allyl chloride, allyl glycidyl ether, acrylic ester, and vinyl ether. The polyvinyl chlorides (A) may be used alone or in combination of two or more.

The polyvinyl chloride (A) may be manufactured using any known polymerization method such as a suspension polymerization method or a bulk polymerization method, for example, and may be manufactured using a suspension polymerization method from the viewpoint of low cost and excellent thermal stability.

The polyvinyl chloride composition for powder molding may contain the polyvinyl chloride (A) in an amount of 25 mass %, or more or 30 mass % or more, for example, but there is no particular limitation thereto. The polyvinyl chloride composition for powder molding may contain the polyvinyl chloride (A) in an amount of 60 mass % or less, or 55 mass % or less, or 50 mass % or less, or 45 mass % or less. More specifically, the polyvinyl chloride composition for powder molding may contain the polyvinyl chloride (A) in an amount of 30 mass % or more and 60 mass % or less, or 35 mass % or more and 55 mass % or less, for example.

The polyvinyl chloride composition for powder molding contains a polyester-based plasticizer. Because the polyester-based plasticizers are less likely to move, the polyester-based plasticizers do not move to the surface of the polyvinyl chloride molded body, and the heat aging resistance is likely to be improved. There is no particular limitation on the blend amount of the polyester-based plasticizer as long as the blend amount is 120 parts by mass or more and 200 parts by mass or less with respect to 100 parts by mass of the polyvinyl chloride (A), and for example, it may be 130 parts by mass or more, 140 parts by mass or more, or 155 parts by mass or more from the viewpoint of increasing the heat aging resistance of the polyvinyl chloride molded body, for example. Also, the blend amount may be 190 parts by mass or less, or 180 parts by mass or less from the viewpoint of facilitating the formation of powder of the polyvinyl chloride composition and from the viewpoint of improving the surface characteristics. More specifically, the blend amount of the polyester-based plasticizer may be 130 parts by mass or more and 200 parts by mass or less, 140 parts by mass or more and 190 parts by mass or less, or 155 parts by mass or more and 180 parts by mass or less, with respect to 100 parts by mass of the polyvinyl chloride (A).

Examples of the polyester-based plasticizer include, but are not particularly limited to, polyester-based plasticizers (their ends may be treated) obtained through a polycondensation reaction between a polycarboxylic acid and a polyalcohol, and polyester-based plasticizers obtained through a transesterification reaction. Examples of the polycarboxylic acid include dicarboxylic acids. Examples of dicarboxylic acids include aliphatic dicarboxylic acids having 2 to 10 carbon atoms such as adipic acid, azelaic acid, and sebacic acid, and aromatic dicarboxylic acids such as phthalic acid, isophthalic acid, and terephthalic acid. Examples of the polyalcohol include glycols having 2 to 10 carbon atoms such as ethylene glycol, propylene glycol, butylene glycol, neopentyl glycol, and hexanediol. Aliphatic dicarboxylic acids such as adipic acid and sebacic acid may be the dicarboxylic acid, and in particular, adipic acid is desirable in terms of versatility, price, and stability over time. Linear or branched glycols may be used and are optionally selected as appropriate. The glycols having 2 to 6 carbon atoms are preferable.

Examples of the adipic acid polyester-based plasticizer include reaction products of adipic acid and one or more dihydric alcohols. Examples of the dihydric alcohol include ethylene glycol, propylene glycol, butanediol, and 1,6-hexanediol. Specific examples thereof include poly(propylene glycol, adipic acid) esters, poly(butanediol, adipic acid) esters, poly(ethylene glycol, adipic acid) esters, poly(1,6-hexanediol, butanediol, adipic acid) esters, poly(butanediol, ethylene glycol, adipic acid) esters, and poly(ethylene glycol, propylene glycol, butanediol, adipic acid) esters.

Although there is no particular limitation on the mass average molecular weight (Mw; also referred to as “weight average molecular weight”) of the polyester-based plasticizer, it may be 500 or more and 3,000 or less, 800 or more and 2,800 or less, or 1,000 or more and 2,500 or less. When the mass average molecular weight is 500 or more, the movement of the polyester-based plasticizer to the surface of the polyvinyl chloride molded body is likely to be suppressed. When the mass average molecular weight is 3000 or less, the polyester-based plasticizer has high cold resistance. In one or more embodiments of the present invention, the mass average molecular weight of a compound is measured using GPC (Gel Permeation Chromatography).

The viscosity of the polyester-based plasticizer at 25° C. is, but is not particularly limited to, may be 100 mPa·s or more and 10,000 mPa·s or less, 100 mPa·s or more and 6,000 mPa·s or less, or 150 mPa·s or more and 5,000 mPa·s or less. When the viscosity is within the above-described range, the movement of the polyester-based plasticizer to the surface of the polyvinyl chloride molded body is more effectively suppressed, and the fluidity is also favorable. In one or more embodiments of the present invention, the viscosity is measured using a B-type viscometer under conditions where the temperature is 25° C. in accordance with JIS K 6901: 1986.

The polyester-based plasticizers may be used alone or in combination of two or more.

In addition to the polyester-based plasticizer, the polyvinyl chloride composition for powder molding may contain other plasticizers that are used as the plasticizer of the polyvinyl chloride in a range such that the aim of one or more embodiments of the present invention is not hindered. Examples of the other plasticizers include trimellitate-based plasticizers, phthalate-based plasticizers, pyromellitate-based plasticizers, epoxy-based plasticizers, and fatty acid ester-based plasticizers. The other plasticizers may be used in an amount of 80 parts by mass or less with respect to 100 parts by mass of the polyvinyl chloride (A), for example.

There is no particular limitation on the blend amount of the acrylic polymer in the polyvinyl chloride composition for powder molding as long as the blend amount is 4 parts by mass or more and 23 parts by mass or less with respect to 100 parts by mass of the polyvinyl chloride (A), and for example, the blend amount may be 5 parts by mass or more, 7 parts by mass or more, or 9 parts by mass or more, from the viewpoint of reducing the dynamic friction coefficient to improve the surface characteristics and suppressing a change in flexibility due to heat aging. The blend amount of the acrylic polymer may be 22 parts by mass or less, or 20 parts by mass or less, with respect to 100 parts by mass of the polyvinyl chloride (A), from the viewpoint of improving the flexibility and flexibility after heat aging. More specifically, the blend amount of the acrylic polymer may be 5 parts by mass or more and 22 parts by mass or less, or 7 parts by mass or more and 20 parts by mass or less, with respect to 100 parts by mass of the polyvinyl chloride (A).

The acrylic polymer contains a constitutional unit derived from methyl (meth)acrylate in an amount of 40 mass % or more and 95 mass % or less, and a constitutional unit derived from at least one (meth) acrylic ester selected from the group consisting of a (meth)acrylic ester of an aliphatic alcohol having two or more carbon atoms and a (meth)acrylic ester of an aromatic alcohol in an amount of 5 mass % or more and 60 mass % or less. The surface characteristics of the polyvinyl chloride molded body can be improved and the flexibility after heat aging can be improved by using such an acrylic polymer. Also, the compatibility between the acrylic polymer and the polyester-based plasticizer is improved, thus making it possible to suppress movement of the polyester-based plasticizer to the surface of the polyvinyl chloride molded body. In the (meth)acrylic ester of an aliphatic alcohol, the aliphatic alcohol may be linear alcohol, or branched alcohol, or cyclic alcohol. In the present disclosure, “(meth)acrylic acid” means acrylic acid and/or methacrylic acid. Also, “(meth)acrylic ester” means acrylic ester and/or methacrylic ester.

Examples of the (meth)acrylic ester of an aliphatic alcohol having two or more carbon atoms, namely (meth)acrylic esters including an alkyl group having two or more carbon atoms, include, but are not particularly limited to, ethyl (meth)acrylate, n-propyl (meth)acrylate, isopropyl (meth)acrylate, n-butyl (methacrylate, isobutyl (meth)acrylate, tert-butyl (meth)acrylate, n-pentyl (meth)acrylate, n-hexyl (meth)acrylate, n-heptyl (meth)acrylate, n-octyl (meth)acrylate, 2-ethylhexyl (meth)acrylate, nonyl (meth)acrylate, decyl (meth)acrylate, dodecyl (meth)acrylate, stearyl (meth)acrylate, cyclohexyl (meth)acrylate, and glycidyl (meth)acrylate. Examples of the (meth)acrylic ester of an aromatic alcohol include, but are not particularly limited to, phenyl (meth)acrylate and benzyl (meth)acrylate. These compounds may be used alone or in combination of two or more. Although there is no particular limitation thereto, it may be that the acrylic polymer includes a (meth)acrylic ester of an aliphatic alcohol having two or more carbon atoms from the viewpoint that a molded body having favorable surface characteristics can be easily obtained.

In the (meth)acrylic ester of an aliphatic alcohol having two or more carbon atoms, there is no particular limitation on the number of carbon atoms, and the number of carbon atoms may be 2 or more and 24 or less from the viewpoint that a molded body having favorable surface characteristics can be easily obtained, 2 or more and 12 or less, or 2 or more and 8 or less from the viewpoint of facilitating emulsion polymerization or fine suspension polymerization. Furthermore, the (meth)acrylic ester of an aliphatic alcohol having two or more carbon atoms may be at least one (meth)acrylic ester of an aliphatic alcohol having 4 carbon atoms selected from the group consisting of n-butyl (meth)acrylate, isobutyl (meth)acrylate, and tert-butyl (meth)acrylate, or at least one (meth)acrylic ester of an aliphatic alcohol having 4 carbon atoms selected from the group consisting of n-butyl (meth)acrylate and isobutyl (meth)acrylate, from the viewpoint of further improving the surface characteristics of the molded body. In addition, the (meth)acrylic ester of an aliphatic alcohol having two or more carbon atoms may include cyclohexyl (meth)acrylate from the viewpoint of further improving the surface characteristics of the molded body. Furthermore, the (meth)acrylic ester of an aliphatic alcohol having two or more carbon atoms may be one or more selected from the group consisting of isobutyl (meth)acrylate and cyclohexyl (meth)acrylate from the viewpoint of excellent powder characteristics.

It may be that the acrylic polymer contains the constitutional unit derived from methyl (meth)acrylate in an amount of 40 mass % or more and 95 mass % or less, and the constitutional unit derived from at least one (meth)acrylic ester selected from the group consisting of n-butyl (meth)acrylate, isobutyl (meth)acrylate, and tert-butyl (meth)acrylate in an amount of 5 mass % or more and 60 mass % or less, from the viewpoint of further improving the surface characteristics of a polyvinyl chloride molded body and improving flexibility after heat aging, for example. It may be that the acrylic polymer contains the constitutional unit derived from methyl (meth)acrylate in an amount of 50 mass % or more and 95 mass % or less, and the constitutional unit derived from at least one (meth)acrylic ester selected from the group consisting of n-butyl (meth)acrylate, isobutyl (meth)acrylate, and tert-butyl (meth)acrylate in an amount of 5 mass % or more and 50 mass % or less, and it may be that the acrylic polymer contains the constitutional unit derived from methyl (meth)acrylate in an amount of 60 mass % or more and 95 mass % or less, and the constitutional unit derived from at least one (meth)acrylic ester selected from the group consisting of n-butyl (meth)acrylate, isobutyl (meth)acrylate, and tert-butyl (meth)acrylate in an amount of 5 mass % or more and 40 mass % or less, from the viewpoint of improving the blocking properties of the polyvinyl chloride composition (powder).

The acrylic polymer may contain a constitutional unit derived from another monomer in addition to the constitutional unit derived from methyl (meth)acrylate and the constitutional unit derived from the (meth)acrylic ester. Examples of the other monomer include carboxyl group-containing monomers, sulfonic group-containing monomers, carbonyl group-containing (meth)acrylates, hydroxyl group-containing (meth)acrylates, epoxy group-containing (meth)acrylates, amide group-containing (meth)acrylates, and amino group-containing (meth)acrylates. Examples of the carboxyl group-containing monomers include methacrylic acid, acrylic acid, itaconic acid, crotonic acid, maleic acid, fumaric acid, 2-succinoloyloxyethyl methacrylate, 2-maleinoyloxyethyl methacrylate, 2-phthaloyloxyethyl methacrylate, and 2-hexahydrophthaloyloxyethyl methacrylate. Examples of the sulfonic group-containing monomers include allylsulfonic acid. Examples of the carbonyl group-containing (meth)acrylates include acetoacetoxyethyl (meth)acrylate.

Examples of the hydroxyl group-containing (meth)acrylates include 2-hydroxyethyl (meth)acrylate and 2-hydroxypropyl (meth)acrylate. Examples of the epoxy group-containing (meth)acrylates include glycidyl (meth)acrylate. Examples of the amide group-containing (meth)acrylates include (meth)acrylamide. Examples of the amino group-containing (meth)acrylates include N-dimethylaminoethyl (meth)acrylate and N-diethylaminoethyl (meth)acrylate. In particular, methacrylic acid and acrylic acid are suitably used from the viewpoint of low costs and high polymerizability with the (meth)acrylic ester. The content of the constitutional unit derived from the other monomer component in the acrylic polymer may be 5 mass % or less.

The average particle diameter (average primary particle diameter) of the acrylic polymer may be, but is not particularly limited to, 0.01 μm or more and 10 μm or less. The average particle diameter of the acrylic polymer may be 0.1 μm or more, or 0.5 μm or more, for example. The average particle diameter of the acrylic polymer may be 5 μm or less, or 2 μm or less, for example. More specifically, the average particle diameter of the acrylic polymer may be 0.1 μm or more and 5 μm or less, or 0.5 μm or more and 2 μm or less, for example. When the average particle diameter of the acrylic polymer is within the above-described range, the fluidity of the powder of the polyvinyl chloride composition is improved, and it can be suitably used as a polyvinyl chloride composition for powder molding. In one or more embodiments of the present invention, the average particle diameter of the acrylic polymer is measured using a dynamic light scattering type particle size distribution measurement apparatus.

There is no particular limitation on the mass average molecular weight of the acrylic polymer, and it may be 50,000 or more and 2,500,000 or less, for example. The mass average molecular weight may be 150,000 or more, 300,000 or more, or 350,000 or more, from the viewpoint of improving flexibility after heat aging. The mass average molecular weight may be 1,350,000 or less, 1,300,000 or less, or 1,200,000 or less, from the viewpoint of improving flexibility after heat aging. More specifically, the mass average molecular weight of the acrylic polymer may be 150,000 or more and 1,350,000 or less, 300,000 or more and 1,300,000 or less, or 350,000 or more and 1,200,000 or less. In one or more embodiments of the present invention, the mass average molecular weight of the acrylic polymer is measured using GPC (Gel Permeation Chromatography).

Although the acrylic polymer may be manufactured using any known polymerization method such as an emulsion polymerization method, a seeded emulsion polymerization method, a fine suspension polymerization method, or a seeded fine suspension polymerization method, it is preferable to use an emulsion polymerization method or fine suspension polymerization method from the viewpoint that such a method facilitates control of the molecular weight, particle structure, and particle diameter and is suitable for industrial production. In the polymerization methods, a polymerization initiator, a surfactant (functioning as an emulsifying agent and/or a dispersing agent), a chain transfer agent, and the like can be used as appropriate.

There is no particular limitation on the polymerization initiator, but sodium persulfate, potassium persulfate, and ammonium persulfate can be used, for example.

There is no particular limitation on the surfactant, but anionic surfactants such as fatty acid salts, alkyl sulfosuccinates, alkyl sarcosinates, alkyl sulfates, and alkylbenzene sulfonates, nonionic surfactants such as polyoxyethylene alkyl ethers, polyoxyethylene fatty acid esters, and glycerin fatty acid esters, and cationic surfactants such as alkylamine salts can be used as appropriate, for example.

There is no particular limitation on the chain transfer agent, but favorable examples include alkyl mercaptans having 2 to 12 carbon atoms in their main chain, and mercapto alcohols. Examples of the alkyl mercaptans having 2 to 12 carbon atoms in their main chain include n-octyl mercaptan (also referred to as “1-octanethiol”), t-octyl mercaptan, n-dodecyl mercaptan, t-dodecyl mercaptan, and 2-ethylhexyl thioglycol. Examples of the mercapto alcohols include 2-mercaptoethanol.

The acrylic polymer may be in the form of particles having a uniform structure, or core-shell particles having a core-shell structure. When the acrylic polymer is in the form of core-shell particles, the mass ratio between the core portion and the shell portion may be within a range from 10:90 to 90:10, for example, but there is no particular limitation thereto.

When the acrylic polymer is in the form of particles having a uniform structure, the acrylic polymer can be produced through spray drying of a latex of a polymer obtained through polymerization of a monomer mixture (also referred to as “one-step polymerization”). When the acrylic polymer is in the form of core-shell particles, the acrylic polymer can be produced by forming a latex of a polymer (core portion) through polymerization of a monomer mixture, adding the additional monomer mixture to the thus-obtained latex and continuing to perform polymerization to form a latex of a polymer (having a core-shell structure), and then performing spray drying (also referred to as “two-step polymerization”). The polymerization of the core portion and/or the shell portion may be performed through two or more steps.

The polyvinyl chloride composition for powder molding may further contain a polyvinyl chloride (B) having an average particle diameter of 0.01 μm or more and less than 50 μm from the viewpoint of further improving flexibility, for example. There is no particular limitation on the average particle diameter of the polyvinyl chloride (B). It may be 0.1 μm or more, or 0.5 μm or more, for example. The average particle diameter of the polyvinyl chloride (B) may be 20 μm or less, or 10 μm or less, for example. More specifically, the average particle diameter of the polyvinyl chloride (B) may be 0.1 μm or more and 20 μm or less, or 0.5 μm or more and 10 μm or less, for example. When the average particle diameter of the polyvinyl chloride (B) is within the above-described range, the fluidity of the powder of the polyvinyl chloride composition is improved. In one or more embodiments of the present invention, the average particle diameter of the polyvinyl chloride (B) can be measured using a laser diffraction-scattering type particle size distribution measurement apparatus such as a particle size distribution measurement apparatus (MICROTRAC/HRA (9320-X100) manufactured by Nikkiso Co., Ltd.).

There is no particular limitation on the average degree of polymerization of the polyvinyl chloride (B), and it may be 500 or more, or 800 or more, for example. There is no particular limitation on the upper limit of the average degree of polymerization of the polyvinyl chloride (B), and it may be 2,000 or less, or 1,500 or less, for example. More specifically, the average degree of polymerization of the polyvinyl chloride (B) may be 500 or more and 2,000 or less, or 800 or more and 1,500 or less, for example. When the average degree of polymerization of the polyvinyl chloride (B) is within the above-described range, the fluidity of the powder of the polyvinyl chloride composition is improved, and the moldability is also improved. In this specification, the average degree of polymerization of the polyvinyl chloride (B) is measured in accordance with JIS K 6720-2:1999.

There is no particular limitation on the polyvinyl chloride (B), for example, a homopolymer of a vinyl chloride monomer and/or a copolymer of a vinyl chloride monomer and another copolymerizable monomer can be used. Examples of the other copolymerizable monomer include, but are not limited to, ethylene, propylene, vinyl acetate, allyl chloride, allyl glycidyl ether, acrylic ester, and vinyl ether.

Although the polyvinyl chloride (B) may be manufactured using any known polymerization method such as an emulsion polymerization method, a seeded emulsion polymerization method, a fine suspension polymerization method, or a seeded fine suspension polymerization method, it is preferable to manufacture the polyvinyl chloride (B) using a fine suspension polymerization method from the viewpoint that fine particles can be easily formed.

In the polyvinyl chloride composition for powder molding, the blend amount of the polyvinyl chloride (B) may be 36 parts by mass or less, 30 parts by mass or less from the viewpoint of reducing the dynamic friction coefficient, or 20 parts by mass or less, with respect to 100 parts by mass of the polyvinyl chloride (A). The lower limit of the blend amount of the polyvinyl chloride (B) may be 3 parts by mass or more, or 5 parts by mass or more, from the viewpoint of improving the fusibility. When the blend amount of the polyvinyl chloride (B) with respect to the polyvinyl chloride (A) is within the above-described range, the fluidity of the powder of the polyvinyl chloride composition is improved.

In the polyvinyl chloride composition for powder molding, the total blend amount of the acrylic polymer and the polyvinyl chloride (B) may be 15 parts by mass or more and 40 parts by mass or less, 15 parts by mass or more and 35 parts by mass or less, or 15 parts by mass or more and 30 parts by mass or less, with respect to 100 parts by mass of the polyvinyl chloride (A), from the viewpoint of reducing the dynamic friction coefficient of the polyvinyl chloride molded body and improving the flexibility after heat aging.

The polyvinyl chloride composition for powder molding may contain an acrylic modified polyorganosiloxane from the viewpoint of further reducing the dynamic friction coefficient of the molded body and improving the surface characteristics, and the blend amount of the acrylic modified polyorganosiloxane may be 0.5 parts by mass or more, or 1 part by mass or more, with respect to 100 parts by mass of the polyvinyl chloride (A), for example. The blend amount of the acrylic modified polyorganosiloxane may be 5 parts by mass or less, or 4 parts by mass or less, with respect to 100 parts by mass of the polyvinyl chloride (A), from the viewpoint of improving the flexibility after heat aging. More specifically, the blend amount of the acrylic modified polyorganosiloxane may be 0.5 parts by mass or more and 5 parts by mass or less, or 1 part by mass or more and 5 parts by mass or less, or 1 part by mass or more and 4 parts by mass or less, with respect to 100 parts by mass of the polyvinyl chloride (A).

In one or more embodiments of the present invention, the content of silicone (polyorganosiloxane) in the acrylic modified polyorganosiloxane is 60 mass % or more. The acrylic modified polyorganosiloxane functions as a lubricant.

Acrylic modified polyorganosiloxane obtained through emulsion graft copolymerization of polyorganosiloxane and (meth)acrylic ester may be used as the acrylic modified polyorganosiloxane, for example.

Examples of the polyorganosiloxane include compounds represented by General Formula (I) below.

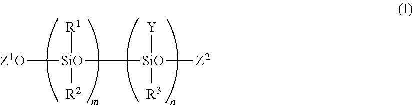

In General Formula (I), R¹, R², and R³ are the same as or different from each other and are individually a hydrocarbon group or a halogenated hydrocarbon group having 1 to 20 carbon atoms. The hydrocarbon group may be an alkyl group or aryl group (e.g., an aryl group having 6 to 10 carbon atoms), for example. The halogenated hydrocarbon group may be a halogenated alkyl group or halogenated aryl group (e.g., a halogenated aryl group having 6 to 10 carbon atoms), for example.

In General Formula (I), Y is a radical reactive group, an SH group, an organic group including a radical reactive group, or an organic group including an SH group. The radical reactive group may be a vinyl group, an allyl group, a γ-acryloxypropyl group, a γ-methacryloxypropyl group, or a γ-mercaptopropyl group, for example.

In General Formula (I), Z¹ and Z² are the same as or different from each other and are individually a hydrogen atom, a lower alkyl group, or a triorganosilyl group. The lower alkyl group may be an alkyl group having 1 to 4 carbon atoms, for example. The triorganosilyl group may be a triorganosilyl group represented by General Formula (II) below, for example.

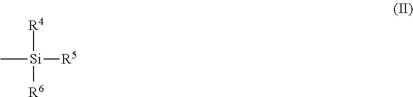

In General Formula (II), R⁴ and R⁵ are the same as or different from each other and are individually a hydrocarbon group or a halogenated hydrocarbon group having 1 to 20 carbon atoms. The hydrocarbon group may be an alkyl group or aryl group (e.g., an aryl group having 6 to 10 carbon atoms), for example. The halogenated hydrocarbon group may be a halogenated alkyl group or halogenated aryl group (e.g., a halogenated aryl group having 6 to 10 carbon atoms), for example.

In General Formula (II), R⁶ is a hydrocarbon group having 1 to 20 carbon atoms, a halogenated hydrocarbon group, a radical reactive group, an SH group, an organic group including a radical reactive group, or an organic group including an SH group. The hydrocarbon group having 1 to 20 carbon atoms may be an alkyl group or aryl group (e.g., an aryl group having 6 to 10 carbon atoms), for example. The halogenated hydrocarbon group may be a halogenated alkyl group or halogenated aryl group (e.g., a halogenated aryl group having 6 to 10 carbon atoms), for example. The radical reactive group may be a vinyl group, an allyl group, a γ-acryloxypropyl group, a γ-methacryloxypropyl group, or a γ-mercaptopropyl group, for example.

In General Formula (I), m is a positive integer that is smaller than or equal to 10,000 (e.g., 500 to 8,000), and n is an integer that is greater than or equal to 1 (e.g., 1 to 500).

In the acrylic modified polyorganosiloxane, the (meth)acrylic ester may be (meth)acrylic ester represented by General Formula (III) below, for example.

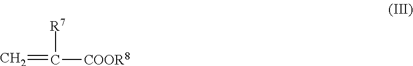

In General Formula (III), R⁷ is a hydrogen atom or a methyl group, and R⁸ is an alkyl group (e.g., an alkyl group having 1 to 18 carbon atoms), an alkoxy-substituted alkyl group (e.g., an alkoxy-substituted alkyl group having 3 to 6 carbon atoms), a cycloalkyl group (e.g., a cycloalkyl group having 6 or 7 carbon atoms), or an aryl group (e.g., an aryl group having 6 to 10 carbon atoms).

The average particle diameter of the acrylic modified polyorganosiloxane may be 0.1 μm or more and 100 μm or less, or 1 μm or more and 100 μm or less, or 5 μm or more and 100 μm or less, or 0.1 μm or more and 80 μm or less, or 0.1 μm or more and less than 50 μm. In one or more embodiments of the present invention, the average particle diameter of the acrylic modified polyorganosiloxane can be measured using a laser diffraction-scattering type particle size distribution measurement apparatus such as a particle size distribution measurement apparatus (MICROTRAC/HRA (9320-X100) manufactured by Nikkiso Co., Ltd.).

Commercially available products such as a silicone/acrylic hybrid resin (CHALINE (registered trademark)) manufactured by Nissin Chemical Industry Co., Ltd. can be used as the acrylic modified polyorganosiloxane, for example.

The polyvinyl chloride composition for powder molding may further contain resin compounding agents such as a stabilizer, a coloring agent, an antioxidant, a filler, and an ultraviolet absorber as appropriate. In addition, the polyvinyl chloride composition for powder molding may also contain a lubricant other than acrylic modified polyorganosiloxane as appropriate.

Epoxy-based stabilizers, barium-based stabilizers, calcium-based stabilizers, tin-based stabilizers, zinc-based stabilizers, hindered amine-based light stabilizers, and composite stabilizers such as calcium-zinc-based (Ca—Zn-based) stabilizers and barium-zinc-based (Ba—Zn-based) stabilizers can also be used as the stabilizer, for example. The stabilizers may be used alone or in combination of two or more. The blend amount of the stabilizer may be 0.01 parts by mass or more and 8 parts by mass or less with respect to 100 parts by mass of the polyvinyl chloride (A).

Examples of the coloring agent include titanium oxide, zinc oxide, and carbon black. Commercially available pigments such as blue pigments or red pigments may also be used as the coloring agent. The coloring agents may be used alone or in combination of two or more.

The polyvinyl chloride composition for powder molding can be manufactured by mixing the polyvinyl chloride (A), the acrylic polymer, and the polyester-based plasticizer, and optionally the polyvinyl chloride (B), the acrylic modified polyorganosiloxane, and other resin compounding agents as appropriate. There is no particular limitation on the mixing method, and for example, a dry blending method may be used. There is no particular limitation on the mixer, and for example a super mixer or the like can be used.

The average particle diameter of the polyvinyl chloride composition for powder molding is not particularly limited, and for example, it may be 50 μm or more, 60 μm or more, 100 μm or more, or 150 μm or more. The average particle diameter of the polyvinyl chloride composition for powder molding is not particularly limited, and for example, it may be 500 μm or less, 300 μm or less, or 200 μm or less. More specifically, the average particle diameter of the polyvinyl chloride composition for powder molding may be 50 μm or more and 500 μm or less, and for example, may be 100 μm or more and 300 μm or less, 100 μm or more and 200 μm or less, or 150 μm or more and 200 μm or less, from the viewpoint of the fluidity of powder. The average particle diameter of the polyvinyl chloride composition for powder molding can be measured in accordance with JIS K 7369:2009.

There is no particular limitation on the adhesive power of the polyvinyl chloride composition for powder molding, and it may be 500 gf/cm² (49 kPa) or less, 300 gf/cm² or less, 250 gf/cm² or less, 200 gf/cm² or less, or 150 gf/cm² or less, from the viewpoint of achieving excellent blocking properties. In one or more embodiments of the present invention, adhesive power is measured and calculated as described later.

The polyvinyl chloride molded body is obtained by molding the polyvinyl chloride composition for powder molding through powder slush molding. Therefore, the composition of the polyvinyl chloride molded body is the same as that of the polyvinyl chloride composition for powder molding. When the cross section of the polyvinyl chloride molded body is observed, an interface between the polyvinyl chloride compositions for powder molding (polyvinyl chloride particles) used in powder slush molding is confirmed. Thus, it is possible to confirm that the molded body is manufactured through powder slush molding, that is, the molded body is a powder slush molded body.

Although there is no particular limitation on the powder slush molding method, a method as described below can be used. That is, a slush molding machine including a powder box and a mold for slush molding (also referred to simply as “mold” hereinafter) is prepared, and the polyvinyl chloride composition for powder molding is introduced into the powder box, while the mold is heated to a predetermined temperature of 230° C. or higher and 280° C. or lower, for example. Next, the slush molding machine is inverted to bring the polyvinyl chloride composition for powder molding into contact with the surface of the mold heated to the predetermined temperature, and is kept in this state for a predetermined period of time (e.g., 3 seconds or more and 15 seconds or less). Thereafter, the slush molding machine is inverted again, and the mold is cooled to a predetermined temperature such as a temperature of 10° C. or higher and 60° C. or lower. Then, a molded body is removed from the cooled mold.

There is no particular limitation on the shape of the polyvinyl chloride molded body, and for example, it may be formed in a sheet-like shape. When the polyvinyl chloride molded body has a sheet-like shape (in this case, the molded body is also referred to as “polyvinyl chloride sheet” hereinafter), there is no particular limitation on its thickness, and for example it may have a thickness of 3.0 mm or less, or 2.0 mm or less, or 1.6 mm or less. In addition, it may have a thickness of 0.5 mm or more, or 0.6 mm or more, or 0.8 mm or more. More specifically, if the polyvinyl chloride molded body has a sheet-like shape, it may have a thickness of 0.5 mm or more and 3.0 mm or less, or 0.6 mm or more and 2.0 mm or less, or 0.8 mm or more and 1.6 mm or less.

When measured in accordance with JIS K 7125:1999, for example, the dynamic friction coefficient of the polyvinyl chloride molded body may be 0.850 or less, 0.820 or less, 0.800 or less, 0.780 or less, 0.740 or less, or 0.700 or less, from the viewpoint of good surface characteristics.

From the viewpoint of high flexibility at a low temperature, the tensile elongation at break of the polyvinyl chloride molded body at −25° C. may be 120% or more, 150% or more, 200% or more, 220% or more, or particularly 230% or more.

The polyvinyl chloride molded body can be suitably used as a facing for a vehicle interior material such as that for an instrument panel, a door trim, a trunk trim, a seat, a pillar cover, a ceiling material, a rear tray, a console box, an air bag cover, an armrest, a headrest, a meter cover, or a crash pad, in a vehicle such as an automobile, but there is no particular limitation thereto.

The polyvinyl chloride molded body and a polyurethane foam layer (also referred to as “polyurethane foam molded body”) can be laminated and used as a laminate. Examples of the lamination method include, but are not particularly limited to, a method in which a polyvinyl chloride molded body and a polyurethane foam molded body are separately produced and then attached to each other through thermal fusion bonding or thermal adhesion, or using a known adhesive; and an isocyanate, polyol, and the like, which are raw materials of a polyurethane foam molded body, are reacted and polymerized on a polyvinyl chloride molded body, and polyurethane is foamed using a known method to form a laminate. The latter method may be used because the process is simple, and the polyvinyl chloride molded body and the polyurethane foam molded body can be reliably adhered to each other even when laminates with various shapes are formed.

The laminate may include a polyurethane foam layer, a polyvinyl chloride molded body (also referred to as “polyvinyl chloride layer”) laminated on one surface of the polyurethane foam layer, and another resin layer laminated on the other surface of the polyurethane foam layer. The other resin layer may be a layer of a polyolefin-based resin (e.g., polypropylene and/or a polyethylene-polypropylene copolymer) or ABS (Acrylonitrile-Butadiene-Styrene) resin, for example. Such a laminate can be manufactured by foaming polyurethane between the polyvinyl chloride layer and the other resin layer, for example.

The laminate can be suitably used as a vehicle interior material such as that for an instrument panel, a door trim, a trunk trim, a seat, a pillar cover, a ceiling material, a rear tray, a console box, an air bag cover, an armrest, a headrest, a meter cover, or a crash pad, in a vehicle such as an automobile, but there is no particular limitation thereto.

### EXAMPLES

Hereinafter, one or more embodiments of the present invention will be described more specifically by use of examples. However, the present invention is not limited to the following examples.

### Manufacturing Example 1 of Acrylic Polymer

Into a 2-L polymerization apparatus including a stirrer, a reflux condenser, a thermometer, a nitrogen gas introduction pipe, and a feed pump, 380 g of deionized water was poured, and was heated under stirring in a nitrogen atmosphere. When the internal temperature of the polymerization apparatus reached 80° C., 23.5 g of an aqueous solution of 2 mass % sodium persulfate was added thereto. Next, a monomer emulsion solution produced by mixing and stirring 420.0 g of methyl methacrylate (MMA), 280.0 g of isobutyl methacrylate (iBMA), 2.5 g of sodium di-(2-ethylhexyl) sulfosuccinate, 0.05 g of 1-octanethiol, and 230.0 g of deionized water was dripped thereinto for 2 hours, and the resulting mixture was stirred for another 2 hours at 80° C. after the dripping was finished. A latex was thus obtained. The thus-obtained latex was cooled to room temperature (about 23° C.), and then an acrylic polymer A1 was manufactured by performing spray drying using a spray dryer (L-12-LS, manufactured by Ohkawara Kakohki Co., Ltd.) under conditions where the inlet temperature was 130° C., the outlet temperature was 60° C., and the atomizer disk rotation speed was 20,000 rpm. The obtained acrylic polymer A1 had an average particle diameter of 0.80 μm and a mass average molecular weight (Mw) of 520,000.

### Manufacturing Example 2 of Acrylic Polymer

An acrylic polymer A2 was manufactured in the same manner as in Manufacturing Example 1, except that the amounts of methyl methacrylate (MMA) and isobutyl methacrylate (iBMA) in the monomer emulsion solution were changed to 560.0 g and 140.0 g, respectively. The obtained acrylic polymer A2 had an average particle diameter of 0.82 μm and a mass average molecular weight (Mw) of 450,000.

### Manufacturing Example 3 of Acrylic Polymer

An acrylic polymer Z1 was manufactured in the same manner as in Manufacturing Example 1, except that the amount of methyl methacrylate (MMA) in the monomer emulsion solution was changed to 700.0 g and isobutyl methacrylate (iBMA) was not used. The obtained acrylic polymer Z1 had an average particle diameter of 0.82 μm and a mass average molecular weight (Mw) of 260,000.

The average particle diameters of the acrylic polymers were measured using a dynamic light scattering type particle size distribution measurement apparatus (“Nanotrac Wave-EX150” manufactured by MicrotracBEL Corp.). The mass average molecular weights (Mw) were measured using a high-speed GPC apparatus (“HCL-8220” manufactured by TOSOH Corporation; Columns: “TSK guard column HZ-H” and “TSK gel Super HZM-H” manufactured by TOSOH Corporation; GPC solvent: THF).

### Example 1

### Manufacturing of Polyvinyl Chloride Composition for Powder Molding

Into a 100-L super mixer (manufactured by KAWATA MFG. Co., Ltd.), 100 parts by mass of the polyvinyl chloride (A) (a vinyl chloride homopolymer with an average degree of polymerization of 2,500 and an average particle diameter of 177 μm; “KS-2500” manufactured by KANEKA Corporation), 130 parts by mass of a polyester-based plasticizer (an adipic acid polyester-based plasticizer with Mw of 2000 and a viscosity of 3000 mPa·s (25° C.); “HPN-3130” manufactured by ADEKA Corporation), 5 parts by mass of zinc stearate as a stabilizer, 1.5 parts by mass of sodium perchlorate as a stabilizer, 0.3 parts by mass of a hindered amine-based light stabilizer (HALS) as a stabilizer, 5 parts by mass of epoxidized soybean oil as a stabilizer, and 3 parts by mass of a pigment (black) were introduced and mixed at 80° C. The thus-obtained mixture was heated and dried, and then cooled to a temperature of 50° C. or lower. 7 parts by mass of the acrylic polymer A1 obtained in Manufacturing Example 1 and 18 parts by mass of the polyvinyl chloride (B1) (a vinyl chloride homopolymer with an average degree of polymerization of 1,300 and an average particle diameter of 10 μm; “PSM-31” manufactured by KANEKA Corporation) were added to the obtained mixture, the resulting mixture was mixed, and thus a polyvinyl chloride composition for powder molding (powder) was produced.

Manufacturing of Polyvinyl Chloride Molded Body

Powder slush molding using the polyvinyl chloride composition for powder molding obtained as described above was performed using a box-type slush molding machine including a mold for slush molding provided with an embossed flat plate (with a length of 22 cm and a width of 31 cm) and a powder box (with a length of 22 cm, a width of 31 cm, and a depth of 16 cm). Specifically, first, 2 kg of the polyvinyl chloride composition for powder molding was introduced into the powder box, and the mold for slush molding heated to 280° C. was set in the slush molding machine. Next, when the temperature of the mold reached 260° C., the slush molding machine was inverted and the polyvinyl chloride composition for powder molding was held in the mold for about 10 to 12 seconds such that a polyvinyl chloride sheet (also referred to as “PVC sheet”) had a thickness of 1.0 mm. Then, the slush molding machine was inverted. After 60 seconds, the mold was cooled to 50° C. using cooling water. Next, the PVC sheet was removed from the mold, and a polyvinyl chloride molded body was thus obtained.

Manufacturing of Laminate

The PVC sheet obtained as described above was placed on the bottom of a mold for foaming (with a length of 190 mm, a width of 240 mm, and a depth of 11 mm). Next, a raw material solution prepared by mixing 36 g of liquid A containing 4,4′-diphenylmethane-diisocyanate and 78 g of liquid B containing polyether polyol (containing 1.0 mass % of triethylenediamine and 1.6 mass % of water) was poured onto the PVC sheet, and the mold was sealed. After a predetermined period of time, a laminate including the PVC sheet (facing) with a thickness of about 1 mm and a polyurethane foam layer (backing material) with a thickness of about 9 mm laminated on the PVC sheet was collected from the mold.

### Example 2

A polyvinyl chloride composition for powder molding, a polyvinyl chloride molded body, and a laminate were produced in the same manner as in Example 1, except that the blend amounts of the polyester-based plasticizer, the acrylic polymer A1 obtained in Manufacturing Example 1, and the polyvinyl chloride (B1) were changed to 145 parts by mass, 5 parts by mass, and 20 parts by mass, respectively.

### Example 3

A polyvinyl chloride composition for powder molding, a polyvinyl chloride molded body, and a laminate were produced in the same manner as in Example 1, except that the blend amount of the polyester-based plasticizer was changed to 145 parts by mass.

### Example 4

A polyvinyl chloride composition for powder molding, a polyvinyl chloride molded body, and a laminate were produced in the same manner as in Example 1, except that the blend amount of the polyester-based plasticizer was changed to 145 parts by mass, and the acrylic polymer A2 obtained in Manufacturing Example 2 was used instead of the acrylic polymer A1 obtained in Manufacturing Example 1, and the polyvinyl chloride (B2) (a vinyl chloride homopolymer with an average degree of polymerization of 1,000 and an average particle diameter of 10 μm; “PSL-31” manufactured by KANEKA Corporation) was used instead of the polyvinyl chloride (B1).

### Example 5

A polyvinyl chloride composition for powder molding, a polyvinyl chloride molded body, and a laminate were produced in the same manner as in Example 1, except that the blend amount of the polyester-based plasticizer was changed to 160 parts by mass.

### Example 6

A polyvinyl chloride composition for powder molding, a polyvinyl chloride molded body, and a laminate were produced in the same manner as in Example 1, except that the blend amounts of the polyester-based plasticizer, the acrylic polymer A1 obtained in Manufacturing Example 1, and the polyvinyl chloride (B1) were changed to 160 parts by mass, 15 parts by mass, and 10 parts by mass, respectively.

### Example 7

A polyvinyl chloride composition for powder molding, a polyvinyl chloride molded body, and a laminate were produced in the same manner as in Example 1, except that the blend amounts of the polyester-based plasticizer, the acrylic polymer A1 obtained in Manufacturing Example 1, and the polyvinyl chloride (B1) were changed to 160 parts by mass, 15 parts by mass, and 15 parts by mass, respectively.

### Comparative Example 1

A polyvinyl chloride composition for powder molding, a polyvinyl chloride molded body, and a laminate were produced in the same manner as in Example 1, except that the blend amount of the polyester-based plasticizer was changed to 110 parts by mass.

### Comparative Example 2

A polyvinyl chloride composition for powder molding, a polyvinyl chloride molded body, and a laminate were produced in the same manner as in Example 3, except that the acrylic polymer Z1 obtained in Manufacturing Example 3 was used instead of the acrylic polymer A1 obtained in Manufacturing Example 1.

### Comparative Example 3

A polyvinyl chloride composition for powder molding, a polyvinyl chloride molded body, and a laminate were produced in the same manner as in Example 5, except that the acrylic polymer was not used and the blend amount of the polyvinyl chloride (B1) was changed to 25 parts by mass.

### Comparative Example 4

A polyvinyl chloride composition for powder molding, a polyvinyl chloride molded body, and a laminate were produced in the same manner as in Example 1, except that the blend amount of the polyester-based plasticizer was changed to 210 parts by mass.

Regarding the examples and comparative examples, the adhesive power of the polyvinyl chloride composition for powder molding was measured as described below, and blocking properties were evaluated. Also, regarding the examples and comparative examples, the dynamic friction coefficient of the polyvinyl chloride molded bodies, and the tensile elongation at break at a low temperature were measured and evaluated as described below. Table 1 below shows the results. “Parts” means “parts by mass” in Table 1 below.

Adhesive Power

After being filled with 40 g of the polyvinyl chloride composition for powder molding, a cylindrical cell with an inner diameter of 5 cm was heated at 30° C. in a constant-temperature oven. After the temperature of the polyvinyl chloride composition for powder molding rose to 30° C., a piston weighing 1.3 kg and a 5-kg weight (total load was 0.32 kgf/cm²) were placed thereon. Then, the cylindrical cell, piston, and weight were kept at 60° C. in the constant-temperature oven for 2 hours. After 2 hours, these were taken out under the conditions of 23° C. and 50% RH and cooled for 1 hour. Then, the weight and piston were removed therefrom, and a cake of the polyvinyl chloride composition for powder molding was taken out of the cylindrical cell. The crushing strength of the thus-obtained cake was measured using a rheometer (RT-2010J-CW manufactured by RHEOTECH), and the adhesive power was calculated using the formula below.

Adhesive power (gf/cm²)=2×B/(3.14×R×D)

B: Load (N) in crushing test
R: Diameter (mm) of cake
D: Thickness (mm) of cake

Dynamic Friction Coefficient

The measurements were performed in accordance with JIS K 7125:1999. Specifically, an NBR rubber sheet (black rubber), which is a partner material, was slid on the PVC sheet using a universal testing machine (“TENSILON” manufactured by A&D Co., Ltd.) with flat indenter specifications at a test rate of 100 mm/minute and a vertical load of 1.96 N under the conditions of 23° C. and 50% RH (relative humidity), and its dynamic friction was measured. Then, the dynamic friction coefficient was calculated therefrom. The dynamic friction coefficients that were smaller than or equal to 0.850 were acceptable.

Tensile Elongation at Break

The PVC sheet was punched into a No. 1 dumbbell shape to obtain a No. 1 dumbbell-shaped sample. Next, the two ends of this sample were held by two chucks (the distance between the chucks was 40 mm). After the sample was kept in a chamber at −25° C. for 3 minutes, a tensile test was performed at a tensile speed of 200 mm/minute to measure the rupture elongation, and the obtained value was used as tensile elongation at break.

TABLE 1

| | | | | | Example | | | | | |
|---|---|---|---|---|---|---|---|---|---|---|
| | | | | | 1 | 2 | 3 | 4 | 5 | 6 |
| Form- | Polyvinyl | | KS-2500 | Parts | 100 | 100 | 100 | 100 | 100 | 100 |
| ulation | chloride | | | | | | | | | |
| of | (A) | | | | | | | | | |
| poly- | Polyester-based | | | Parts | 130 | 145 | 145 | 145 | 160 | 160 |
| vinyl | plasticizer | | | | | | | | | |
| chloride | Polyvinyl | | PSM-31 | Parts | 18 | 20 | 18 | — | 18 | 10 |
| comp- | chloride | | | | | | | | | |
| osition | (B1) | | | | | | | | | |
| | Polyvinyl | | PSL-31 | Parts | — | — | — | 18 | — | — |
| | chloride | | | | | | | | | |
| | (B2) | | | | | | | | | |
| | Acrylic | A1 | MMA/ | Parts | 7 | 5 | 7 | — | 7 | 15 |
| | poly- | | iBMA = | | | | | | | |
| | mer | | 60/40 | | | | | | | |
| | | A2 | MMA/ | Parts | — | — | — | 7 | — | — |
| | | | iBMA = | | | | | | | |
| | | | 80/20 | | | | | | | |
| | | Z1 | MMA/ | Parts | — | — | — | — | — | — |
| | | | iBMA = | | | | | | | |
| | | | 100/0 | | | | | | | |

| Physical | Dynamic | JIS K 7125 | — | 0.752 | 0.723 | 0.568 | 0.510 | 0.811 | 0.607 |
|---|---|---|---|---|---|---|---|---|---|
| properties | friction | | | | | | | | |
| of | coefficient | | | | | | | | |
| polyvinyl | Tensile elongation | | % | 205 | 228 | 238 | 221 | 283 | 233 |
| chloride | at break | | | | | | | | |
| molded | | | | | | | | | |
| body | | | | | | | | | |
| Powder | Blocking | Adhesive | gf/cm² | 200 | 140 | 180 | 150 | 500 | 250 |
| character- | properties | power | | | | | | | |
| istics | | | | | | | | | |

| | | | | | Example | Comparative Example | | | |
|---|---|---|---|---|---|---|---|---|---|
| | | | | | 7 | 1 | 2 | 3 | 4 |
| Form- | Polyvinyl | | KS-2500 | Parts | 100 | 100 | 100 | 100 | 100 |
| ulation | chloride | | | | | | | | |
| of | (A) | | | | | | | | |
| poly- | Polyester-based | | | Parts | 160 | 110 | 145 | 160 | 210 |
| vinyl | plasticizer | | | | | | | | |
| chloride | Polyvinyl | | PSM-31 | Parts | 15 | 18 | 18 | 25 | 18 |
| comp- | chloride | | | | | | | | |
| osition | (B1) | | | | | | | | |
| | Polyvinyl | | PSL-31 | Parts | — | — | — | — | — |
| | chloride | | | | | | | | |
| | (B2) | | | | | | | | |
| | Acrylic | A1 | MMA/ | Parts | 15 | 7 | — | — | 7 |
| | poly- | | iBMA = | | | | | | |
| | mer | | 60/40 | | | | | | |
| | | A2 | MMA/ | Parts | — | — | — | — | — |
| | | | iBMA = | | | | | | |
| | | | 80/20 | | | | | | |
| | | Z1 | MMA/ | Parts | — | — | 7 | — | — |
| | | | iBMA = | | | | | | |
| | | | 100/0 | | | | | | |

| Physical | Dynamic | JIS K 7125 | — | 0.607 | 0.627 | 0.904 | 1.754 | 1.450 |
|---|---|---|---|---|---|---|---|---|
| properties | friction | | | | | | | |
| of | coefficient | | | | | | | |
| polyvinyl | Tensile elongation | | % | 223 | 109 | 222 | 327 | 335 |
| chloride | at break | | | | | | | |
| molded | | | | | | | | |
| body | | | | | | | | |
| Powder | Blocking | Adhesive | gf/cm² | 220 | 220 | 310 | 900 | 1150 |
| character- | properties | power | | | | | | |
| istics | | | | | | | | |

As is clear from the results shown in Table 1 above, the polyvinyl chloride molded bodies of Examples 1 to 7 had high tensile elongation at break at −25° C. and good flexibility at a low temperature. The polyvinyl chloride molded bodies of Examples 1 to 7 had low dynamic friction coefficient, and the surface characteristics were favorable. Also, the polyvinyl chloride compositions of Examples 1 to 7 had a adhesive power of 500 gf/cm² or less, and the blocking properties were favorable.

On the other hand, as is clear from the results shown in Table 1, the polyvinyl chloride molded body of Comparative Example 1 in which the blend amount of the polyester-based plasticizer was less than 120 parts by mass with respect to 100 parts by mass of the polyvinyl chloride (A) had low tensile elongation at break at −25° C. and had poor flexibility at a low temperature. The polyvinyl chloride molded body of Comparative Example 4 in which the blend amount of the polyester-based plasticizer exceeded 200 parts by mass with respect to 100 parts by mass of the polyvinyl chloride (A) had high dynamic friction coefficient, the surface characteristics were also poor, the adhesive power exceeded 500 gf/cm², and the blocking properties were poor. In the case of Comparative Example 2 in which the acrylic polymer containing the constitutional unit derived from methyl (meth)acrylate in an amount of 100 mass %, the dynamic friction coefficient was high, and the surface characteristics were poor. In the case of Comparative Example 3, which did not contain the acrylic polymer, the dynamic friction coefficient was high, the surface characteristics were poor, the adhesive power exceeded 500 gf/cm², and the blocking properties were poor.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

1. A polyvinyl chloride composition for powder molding, comprising:
a polyvinyl chloride (A) in an amount of 100 parts by mass;
a polyester-based plasticizer in an amount of 120 parts by mass or more and 200 parts by mass or less; and
an acrylic polymer in an amount of 4 parts by mass or more and 23 parts by mass or less,
wherein the polyvinyl chloride (A) has an average particle diameter of 50 μm or more and 500 μm or less and an average degree of polymerization of 1,700 or more, and
wherein the acrylic polymer comprises a constitutional unit derived from methyl (meth)acrylate in an amount of 40 mass % or more and 95 mass % or less, and a constitutional unit derived from at least one (meth)acrylic ester in an amount of 5 mass % or more and 60 mass % or less, wherein the constitutional unit derived from at least one (meth)acrylic ester is selected from the group consisting of a (meth)acrylic ester of an aliphatic alcohol having two or more carbon atoms, and a (meth)acrylic ester of an aromatic alcohol.

2. The polyvinyl chloride composition for powder molding according to claim 1,
wherein the acrylic polymer has an average particle diameter of 0.01 μm or more and 10 μm or less.

3. The polyvinyl chloride composition for powder molding according to claim 1,
wherein the constitutional unit derived from the at least one (meth)acrylic ester is selected from the group consisting of n-butyl (meth)acrylate, isobutyl (meth)acrylate, and tert-butyl (meth)acrylate.

4. The polyvinyl chloride composition for powder molding according to claim 1, further comprising:
a polyvinyl chloride (B) having an average particle diameter of 0.05 μm or more and less than 50 μm,
wherein a blend amount of the polyvinyl chloride (B) is 36 parts by mass or less with respect to 100 parts by mass of the polyvinyl chloride (A).

5. The polyvinyl chloride composition for powder molding according to claim 1, further comprising:
an acrylic modified polyorganosiloxane,
wherein a blend amount of the acrylic modified polyorganosiloxane is 5 parts by mass or less with respect to 100 parts by mass of the polyvinyl chloride (A).

6. A polyvinyl chloride molded body obtained by molding the polyvinyl chloride composition for powder molding according to claim 1 through powder slush molding.

7. The polyvinyl chloride molded body according to claim 6, wherein the polyvinyl chloride molded body is a facing for a vehicle interior material.

8. The polyvinyl chloride molded body according to claim 6,
wherein the acrylic polymer has an average particle diameter of 0.01 μm or more and 10 μm or less.

9. The polyvinyl chloride molded body according to claim 6,
wherein the constitutional unit derived from the at least one (meth)acrylic ester is selected from the group consisting of n-butyl (meth)acrylate, isobutyl (meth)acrylate, and tert-butyl (meth)acrylate.

10. The polyvinyl chloride molded body according to claim 6,
wherein the polyvinyl chloride composition for powder molding further comprises a polyvinyl chloride (B) having an average particle diameter of 0.05 μm or more and less than 50 μm, and
wherein a blend amount of the polyvinyl chloride (B) is 36 parts by mass or less with respect to 100 parts by mass of the polyvinyl chloride (A).

11. The polyvinyl chloride molded body according to claim 6,
wherein the polyvinyl chloride composition for powder molding further comprises an acrylic modified polyorganosiloxane, and
wherein a blend amount of the acrylic modified polyorganosiloxane is 5 parts by mass or less with respect to 100 parts by mass of the polyvinyl chloride (A).

12. A laminate obtained by laminating a polyurethane foam layer and the polyvinyl chloride molded body according to claim 6.

13. The laminate according to claim 12, wherein the laminate is a vehicle interior material.
